(19) United States
(12) Patent Application Publication
(10) Pub. No.: US 2023/0268589 A1
(43) Pub. Date: Aug. 24, 2023

(54) INFLATABLE POUCH DESIGNS FOR ELECTROCHEMICAL CELLS AND METHODS OF FORMING THE SAME

(71) Applicant: GM GLOBAL TECHNOLOGY OPERATIONS LLC, Detroit, MI (US)

(72) Inventor: Meng JIANG, Rochester Hills, MI (US)

(73) Assignee: GM GLOBAL TECHNOLOGY OPERATIONS LLC, Detroit, MI (US)

(21) Appl. No.: 17/678,406

(22) Filed: Feb. 23, 2022

(51) Int. Cl. H01M 50/105; H01M 50/133; H01M 50/124

(52) U.S. Cl. CPC H01M 50/105; H01M 50/133; H01M 50/1245

(57) ABSTRACT

The present disclosure provides a thermally stable battery pouch that includes one or more films assembled together to define a cavity, where a stack including a plurality of electrochemical cells and an electrolyte are disposed in the cavity. The cavity is at least about 50% larger than the stack. In certain variations, the thermally stable battery pouch further includes an elastic material film that coats at least a portion of an exterior surface of the one or more films. A method for forming the thermally stable battery pouch is also provided. The method includes adding the electrolyte to a precursor battery pouch via an opening, where the precursor battery pouch defines the cavity, and sealing the opening of the precursor battery pouch having the electrolyte and the stack disposed therein to form the thermally stable battery pouch.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries or semi-solid-state batteries, a solid-state electrolyte may physically separate the electrodes so that a distinct separator is not required.

In various aspects, lithium-ion batteries can be provided in the form of pouch cells, where the electrodes and electrolyte and/or separator are disposed in a pouch. Typical pouch cells are formed from a film (e.g., metal foil laminated with one or more polymeric layers) that is sealed to form an enclosure that carries the electrodes end electrolyte and/or separator. During battery thermal runaway, heat is release which causes solvents present, for example, in the electrolyte, to evaporate. The resulting gases often cause the pouch materials to bulge, and in certain instances, burst at one or more of the sealing locations and electrolyte to be released. Upon exposure to the air, and the high temperature environment, the electrolyte may ignite. Accordingly, it would be desirable to develop pouch materials and designs that can accommodate volumetric expansions and help to maintain the integrity of the pouch and eliminate or reduce leaks and improve safety.

### SUMMARY

This section provides a general summary of the disclosure, and is not a comprehensive disclosure of its full scope or all of its features.

The present disclosure relates to pouches designed to encompass and hold electrochemical cells, and methods of forming and using the same.

In various aspects, the present disclosure provides a thermally stable battery pouch that includes one or more films assembled together to define a cavity, where a stack including a plurality of electrochemical cells and an electrolyte are disposed in the cavity. The cavity may be at least about 50% larger than the stack.

In one aspect, the cavity may include one or more pockets disposed on one or more sides of the stack.

In one aspect, the electrolyte may fill greater than or equal to about 0.1 vol. % to less than or equal to about 10 vol. % of a total space between the one or more electrochemical cells and an interior surface of the one or more films.

In one aspect, the thermally stable battery pouch may further include an elastic material film that coats at least a portion of an exterior surface of the one or more films.

In one aspect, the elastic material film may have a thickness greater than or equal to about 10 μm to less than or equal to about 1 mm.

In one aspect, the elastic material film may include an elastic material selected from the group consisting of: rubber, latex, polychloroprene, nanotube rubber, fluoroelastomers, nylon fabric, and combinations thereof.

In various aspects, the present disclosure provides a thermally stable battery pouch that includes one or more films assembled together to define a cavity, an elastic material film that coats at least a portion of an exterior surface of the one or more films, and a stack include a plurality of electrochemical cells disposed in the cavity with an electrolyte. The one or more films may include a metal foil laminated with one or more polymeric layers.

In one aspect, the elastic material film may have a thickness greater than or equal to about 1 μm to less than or equal to about 1 mm.

In one aspect, the elastic material film may include an elastic material selected from the group consisting of: rubber, latex, polychloroprene, nanotube rubber, fluoroelastomers, nylon fabric, and combinations thereof.

In one aspect, the cavity may include one or more pockets disposed on one or more sides of the stack.

In one aspect, the cavity may be at least about 50% larger than the stack.

In one aspect, the electrolyte may fill greater than or equal to about 0.1 vol. % to less than or equal to about 10 vol. % of a total space between the one or more electrochemical cells and an interior surface of the one or more polymeric films.

In various aspects, the present disclosure provides a method for forming a thermally stable battery pouch. The method may include adding an electrolyte to a precursor battery pouch via an opening, where the precursor battery pouch defines a cavity configured to hold a stack including a plurality of electrochemical cell, and sealing the opening of the precursor battery pouch having the electrolyte and the stack disposed therein to form the thermally stable battery pouch. The cavity may be at least about 50% larger than the stack.

In one aspect, the method may further include preparing the precursor battery pouch.

In one aspect, the method may further include preparing the precursor battery and preparing the precursor battery may include aligning one or more films, and sealing one or more edges of the one or more films to define the cavity of the precursor battery pouch and the opening.

In one aspect, after the preparing, the method may further include adding the stack of the one or more electrochemical cells to the cavity of the precursor battery pouch.

In one aspect, the aligning of the one or more films may include positioning the one or more films around the stack of the one or more electrochemical cells.

In one aspect, the method may further include contacting one or more exterior surfaces of the precursor battery pouch with an elastic material to form an elastic material film that coats at least a portion of an exterior surface of the thermally stable battery pouch.

In one aspect, the elastic material may be selected from the group consisting of: rubber, latex, polychloroprene, nanotube rubber, fluoroelastomers, nylon fabric, and combinations thereof.

In one aspect, the method may further include, after the sealing, degassing the sealed precursor battery pouch to form the thermally stable battery pouch.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a top-down illustration of an example battery pouch in accordance with various aspects of the present disclosure;

FIG. 2 is an illustration of an example electrochemical cell (for example, as carried by the example battery pouch illustrated in FIG. 1) in accordance with various aspects of the present disclosure;

FIG. 3 is an illustration of another example battery pouch in accordance with various aspects of the present disclosure;

FIG. 4 is an illustration of yet another example battery pouch in accordance with various aspects of the present disclosure;

FIG. 5 is a flowchart summarizing an example method for forming a battery pouch (for example, the example battery pouch illustrated in FIG. 1) in accordance with various aspects of the present disclosure;

FIG. 6 is a flowchart summarizing an example method for forming a battery pouch (for example, the example battery pouch illustrated in FIG. 3), in accordance with various aspects of the present disclosure; and

FIG. 7 is a flowchart summarizing an example method for forming a battery pouch (for example, the example battery pouch illustrated in FIG. 4), in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

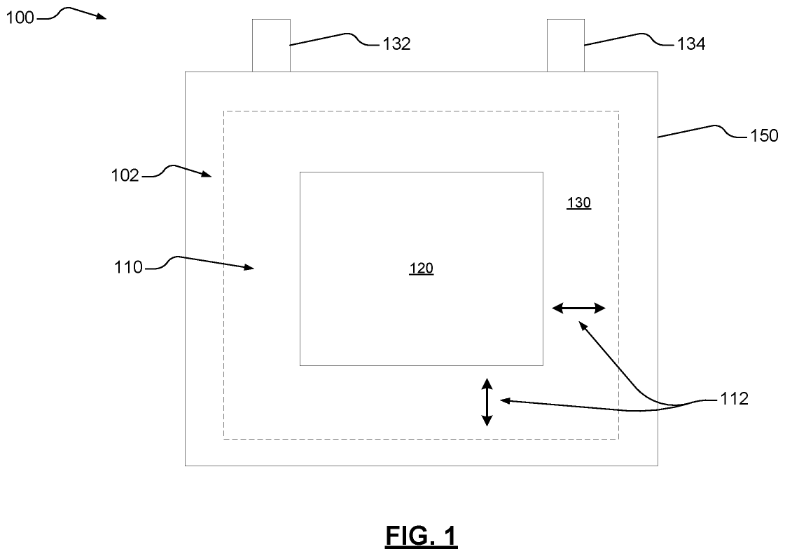

In various aspects, as illustrated in FIG. 1, the present disclosure provides a battery pouch 100 that is designed to encompass and hold a plurality or one or more electrochemical cells 120. The battery pouch 100 may take a variety of configurations. For example, in certain variations, as illustrated, the battery pouch 100 may be substantially rectangular. In other variations, although not illustrated, the battery pouch 100 may form a square, or various other shapes as would be recognized by the skilled artisan. In each variation, the battery pouch 100 includes one or more films 150 having one or more sealed edges 102 that define a cavity 110. For example, although not specifically illustrated, the skilled artisan will understand that the battery pouch 100 may include a first or top film substantially aligned with a second or bottom film, where the first film is bonded to the second film on four sides. In each instance, the cavity 110 encompasses and holds the one or more electrochemical cells 120, such that the electrochemical cells 120 are maintained in a controlled environment. The film may include a metal foil where at least one surface of the metal foil is coated with one or more polymeric layers.

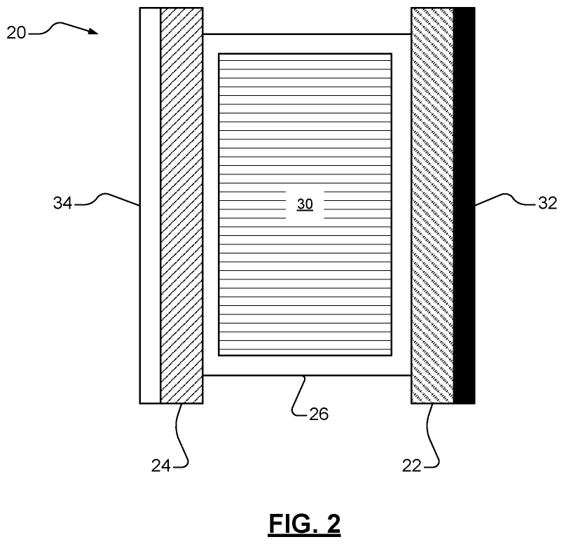

Typical electrochemical cells include a first electrode (such as a positive electrode or cathode) opposing a second electrode (such as a negative electrode or anode) and a separator and/or electrolyte disposed therebetween. For example, an exemplary and schematic illustration of an electrochemical cell (also referred to as the battery) 20 is shown in FIG. 2. The battery pouch 100 may surround and hold one or more electrochemical cell 120, like the electrochemical cell 20 illustrated in FIG. 2. For example, the battery pouch 100 may include a plurality of electrochemical cells 120 connected in series or parallel with other similar lithium-ion cells or batteries to produce a greater voltage output, energy, and power.

In various aspects, the electrochemical cell 20 includes a negative electrode 22, a positive electrode 24, and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. The electrolyte 30 is capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In various aspects, the separator 26 may be a microporous polymeric separator. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. In certain variations, the negative electrode 22 may include a plurality of solid-state electrolyte particles (not shown). The negative electrode 22 may have an average thickness greater than or equal to about 500 nm to less than or equal to about 500 μm, and in certain aspects, optionally greater than or equal to about 10 μm to less than or equal to about 200 μm. In certain variations, the negative electrode 22 may have an average thickness greater than or equal to 500 nm to less than or equal to 500 μm, and in certain aspects, optionally greater than or equal to 10 μm to less than or equal to 200 μm.

The negative electrode 22 may include a negative electroactive material that comprises lithium, such as, for example, lithium alloys (e.g., lithium titanium oxide (LTO)) and/or lithium metal. In certain variations, the negative electrode may be a film or layer formed of lithium metal. Other materials can also be used to form the negative electrode 22, including, for example, carbonaceous materials (such as, graphite, hard carbon, soft carbon), and/or lithium-silicon, silicon containing binary and ternary alloys (e.g., Si, Li—Si, SiOₓ (where 0≤x≤2), FeS, and the like), and/or tin-containing alloys (e.g., Si—Sn, SiSnFe, SiSnAl, SiFeCo, SnO₂, and the like), and/or metal oxides (e.g., V₂O₅, SnO₂, Co₃O₄, and the like), and/or combinations thereof. For example, in certain variations, the negative electroactive material may include a carbonaceous-silicon based composite including, for example, about 10 wt. % SiOₓ (where 0≤x≤2) and about 90 wt. % graphite. Further still, in certain variation, the negative electroactive material may be pre-lithiated.

In various aspects, the negative electroactive material in the negative electrode 22 may be optionally intermingled with one or more electronically conductive materials that provide an electron conductive path and/or one or more binder materials that help to improve the structural integrity of the negative electrode 22.

For example, the negative electroactive material in the negative electrode 22 may be optionally intermingled (e.g., slurry casted) with binders like polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate.

The electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. In certain aspects, mixtures of the conductive materials may be used.

In various aspects, the negative electrode 22 may include greater than or equal to about 10 wt. % to less than or equal to about 99 wt. %, and in certain aspects, optionally greater than or equal to about 60 wt. % to less than or equal to about 99 wt. %, of the negative electroactive material; greater than or equal to 0 wt. % to less than or equal to about 40 wt. %, and in certain aspects, optionally greater than or equal to about 0.5 wt. % to less than or equal to about 20 wt. %, of the electronically conducting material; and greater than or equal to 0 wt. % to less than or equal to about 40 wt. %, and in certain aspects, optionally greater than or equal to about 0.5 wt. % to less than or equal to about 20 wt. %, of the at least one polymeric binder.

In certain variations, the negative electrode 22 may include greater than or equal to 10 wt. % to less than or equal to 99 wt. %, and in certain aspects, optionally greater than or equal to 60 wt. % to less than or equal to 99 wt. %, of the negative electroactive material; greater than or equal to 0 wt. % to less than or equal to 40 wt. %, and in certain aspects, optionally greater than or equal to 0.5 wt. % to less than or equal to 20 wt. %, of the electronically conducting material; and greater than or equal to 0 wt. % to less than or equal to 40 wt. %, and in certain aspects, optionally greater than or equal to 0.5 wt. % to less than or equal to 20 wt. %, of the at least one polymeric binder.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. In certain variations, the positive electrode 24 may have a thickness greater than or equal to 1 μm to less than or equal to 500 μm, and in certain aspects, optionally greater than or equal to 10 μm to less than or equal to 200 μm.

In various aspects, the positive electroactive material may be an olivine compound (e.g., LiV₂(PO₄)₃ LiFePO₄, LiCoPO₄, LiMnFePO₄ (LMFP), and the like); rock salt layered oxides having, for example, the general formula LiNiₓMn_{y}Co_{1-x-y}O₂ (where 0.05≤x≤0.99), LiNiₓMn₁₋ₓO₂(where 0.5≤x≤0.95), or Li₁₊ₓMO₂ (where 0.01≤x≤0.3) (e.g., LiCoO₂, LiNiO₂, LiMnO₂, LiNi_{0.5}Mn_{0.5}O₂, NMC111, NMC523, NMC622, NMC721, NMC811, NCA, NCMA, and the like); spinel compounds (e.g., LiMn₂O₄, LiNi_{0.5}Mn_{1.5}O₄, and the like); tavorite compounds (e.g., LiVPO₄F and the like); borate compounds (e.g., LiFeBO₃, LiCoBO₃, LiMnBO₃, and the like); silicate compounds (e.g., Li₂FeSiO₄, Li₂MnSiO₄, LiMnSiO₄F, and the like); organic compounds (e.g., dilithium (2,5-dilithiooxy)terephthalate, polyimide, and the like), and combinations thereof.

In various aspects, the positive electroactive material in the positive electrode 24 may be optionally intermingled with one or more electronically conductive materials that provide an electron conductive path and/or one or more binder materials that help to improve the structural integrity of the positive electrode 24.

For example, the positive electroactive material in the positive electrode 24 may be optionally intermingled (e.g., slurry casted) with binders like polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate.

The electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. In certain aspects, mixtures of the conductive materials may be used.

In various aspects, the positive electrode 24 may include greater than or equal to about 10 wt. % to less than or equal to about 99 wt. %, and in certain aspects, optionally include greater than or equal to about 90 wt. % to less than or equal to about 99 wt. %, of the negative electroactive material; greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 5 wt. %, of the electronically conducting material; and greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 9 wt. %, of the at least one polymeric binder.

In certain variations, the positive electrode 24 may include greater than or equal to 10 wt. % to less than or equal to 99 wt. %, and in certain aspects, optionally include greater than or equal to 90 wt. % to less than or equal to 99 wt. %, of the negative electroactive material; greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 5 wt. %, of the electronically conducting material; and greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 9 wt. %, of the at least one polymeric binder.

The electrochemical cell further comprises a first current collector 32 (e.g., a negative current collector) positioned at or near the negative electrode 22, and a second current collector 34 (e.g., a positive current collector) may be positioned at or near the positive electrode 24. The first current collector 32 may be a metal foil, metal grid or screen, or expanded metal comprising copper or any other appropriate electronically conductive material known to those of skill in the art. The second electrode current collector 34 may be a metal foil, metal grid or screen, or expanded metal comprising aluminum or any other appropriate electronically conductive material known to those of skill in the art.

The first current collector 32 and the second current collector 34 may respectively collect and move free electrons to and from an external circuit. For example, although not illustrated, the skilled artisan will understand that an interruptible external circuit and a load device may connect the negative electrode 22 (through the first current collector 32) and the positive electrode 24 (through the second current collector 34). The battery 20 can generate electric current to the load device. The load device may be powered by the electric current passing through the external circuit when the battery 20 is discharging. While the electrical load device may be any number of known electrically-powered devices, a few specific examples include an electric motor for an electrified vehicle, a laptop computer, a tablet computer, a cellular phone, and cordless power tools or appliances. The load device may also be an electricity-generating apparatus that charges the battery 20 for purposes of storing electrical energy.

In various aspects, the electrochemical cell 20 may also include a variety of other components that, while not depicted here, are nonetheless known to those of skill in the art. For instance, the electrochemical cell 20 may include a casing, gaskets, terminal caps, tabs, battery terminals, and any other conventional components or materials that may be situated within the electrochemical cell 20, including between or around the negative electrode 22, the positive electrode 24, and/or the separator 26. The electrochemical cell 20 shown in FIG. 2 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

With renewed reference to FIG. 1, the battery pouch 100 is configured such that excess space or pouch material is disposed along at least one side of the one or more electrochemical cells 120. For example, the cavity 110 may be at least about 50%, optionally about 100%, and in certain aspects, optionally about 200%, larger than the one or more electrochemical cells 120. That is, the cavity 110 has dimensions such that its volume is at least 50%, optionally about 100%, and in certain aspects, optionally about 200%, larger than necessary to accommodate the one or more of electrochemical cells 120. In certain variations, the cavity 110 may be at least 50%, optionally 100%, and in certain aspects, optionally 200%, larger than the one or more electrochemical cells 120.

As illustrated, the one or more electrochemical cells 120 may be positioned in a center of the cavity 110 and excess space or cavity pockets 112 may be disposed along each side of the electrochemical cells 120, as grouped. Although not illustrated, the skilled artisan will recognized that in various aspects, the one or more electrochemical cells may be positioned nearer to one or more of the edges or seals of the battery punch and extra space or pockets define along one or more of the remaining edges or seals of the battery pouch. In each variation, the excess pouch material on one or more sides of the electrochemical cells 120 may be folded or rolled into a shape that has dimensions similar to the cell thickness such that the battery pouch 100 has a desired shape and/or size.

The cavity 100, including the one or more cavity pockets 112, further include an electrolyte 130. The electrolyte 130 surrounds the one or more electrochemical cells 120 and only partially fills the space or void between the one or more electrochemical cells 120 and an interior wall or surface of the pouch 100 (i.e., the cavity pockets 112). For example, the electrolyte 130 may fill greater than or equal to about 0.1 vol. % to less than or equal to about 10 vol. %, and in certain aspects, optionally greater than or equal to 0.1 vol. % to less than or equal to 10 vol. %, of the total space between the one or more electrochemical cells 120 and an interior wall or surface of the pouch 100. That is, the electrolyte 130 may fill greater than or equal to about 0.1 vol. % to less than or equal to about 10 vol. %, and in certain aspects, optionally greater than or equal to 0.1 vol. % to less than or equal to 10 vol. %, of the cavity pockets 112. The excess space or cavity pockets 112 may help to accommodate volumetric expansion during thermal events such that the electrolyte 130 does not readily leak from the battery pouch 100. The electrolyte 130 may be the same as or different from an electrolyte disposed within the one or more electrochemical cells 120 (such as, the electrolyte 30 included in the electrochemical cell 20 illustrated in FIG. 2). For example, the electrolyte 130 may be a non-aqueous liquid electrolyte solution (e.g., >1M) that includes a lithium salt dissolved in an organic solvent or a mixture of organic solvents.

In various aspects, the battery pouch 100 may further include one or more battery tabs 132, 134. For example as illustrated, the one or more battery tabs 132, 134 may extend from the battery pouch 100. As illustrated, the one or more battery tabs 132, 134 may include a first battery tab and a second battery tab 132. In certain variations, the first and second battery tabs may extend from the same side of the battery pouch 100. In other variations, the first and second battery tabs may extend from different sides of the battery pouch 100. In each instance, the battery tabs 132, 134 may be in communication with one or more current collectors (not shown) of the one or more electrochemical cells 120. The one or more battery tabs 132, 134 may allow for electrons to flow through each electrochemical cell within the battery pouch 100.

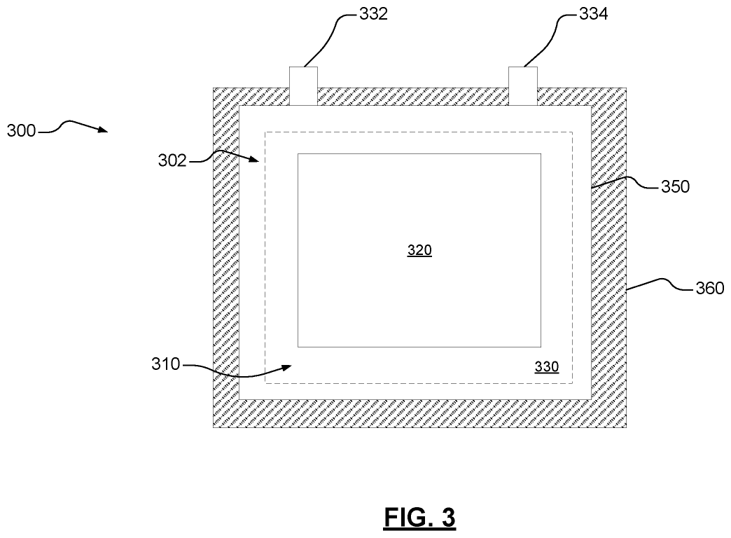

FIG. 3 illustrates another battery pouch 300 that is designed to encompass and hold one or more electrochemical cells 320 (like the electrochemical cell 20 illustrated in FIG. 2) and accommodate volumetric expansion during thermal events such that an electrolyte 330 does not readily leak from the battery pouch 300. As illustrated, like the battery pouch 100, the battery pouch 300 includes one or more films 350 having one or more sealed edges 302 the define a cavity 310, where the cavity 310 encompasses and holds the one or more electrochemical cells 320, such that the electrochemical cells 320 are maintained in a controlled environment. The cavity 310 is only slightly larger than the one or more electrochemical cells 320. However, like the cavity 110 illustrated in FIG. 1, the cavity 310 further includes the electrolyte 330. Moreover, like the battery pouch 100 illustrated in FIG. 1, the battery pouch 300 may further include one or more battery tabs 332, 334.

In various aspects, the battery pouch 300 includes an elastic material 350 that surround at least a portion of the one or more films 350. For example, the elastic material 350 may form a coating or coatings on one or more portions of the one or more films 350. The coating or coatings may have a thickness greater than or equal to about 10 μm to less than or equal to about 1 mm, and in certain aspects, optionally greater than or equal to 10 μm to less than or equal to 1 mm. The elastic material 350 may include, for example only, rubber, latex, polychloroprene, nanotube rubber, fluoroelastomers, nylon fabric, and combinations thereof. In each variation, the elastic material 350 helps to accommodate volumetric expansions during thermal events. For example, the elastic material 350 will accommodate electrolyte gas when a leak from the battery pouch 300 occurs. More particularly, the elastic material 350 will expand when the gas volume increases with temperature.

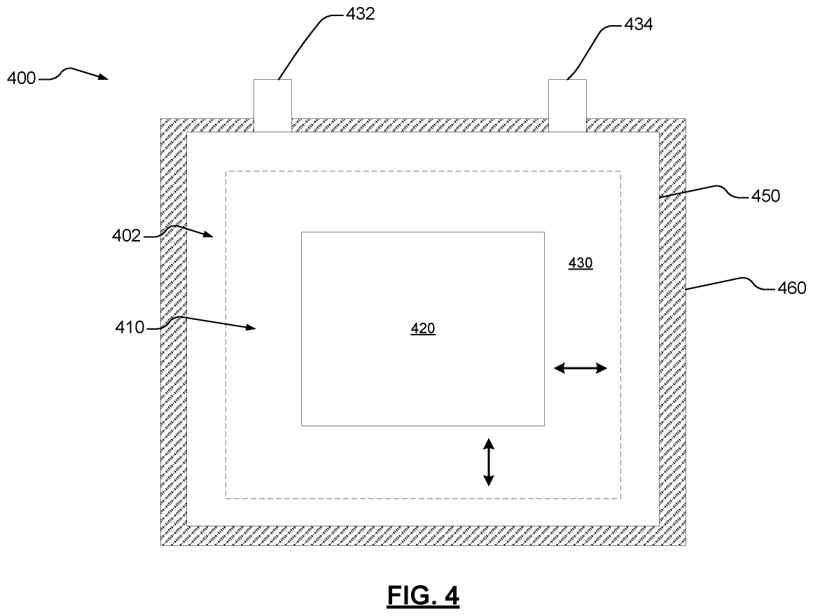

FIG. 4 illustrates another battery pouch 400 that is designed to encompass and hold one or more electrochemical cells 420 (like the electrochemical cell 20 illustrated in FIG. 2) and accommodate volumetric expansion during thermal events such that an electrolyte 430 does not readily leak from the battery pouch 400. Like both the battery pouch 100 illustrated in FIG. 1 and the battery pouch 300 illustrated in FIG. 3, the battery pouch 400 includes one or more films 450 having one or more sealed edges 402 the define a cavity 410, where the cavity 410 encompasses and holds the one or more electrochemical cells 420, such that the electrochemical cells 420 are maintained in a controlled environment. Like the battery pouch 100 illustrated in FIG. 1, the battery pouch 400 may be configured such that excess space or pouch material is disposed along at least one side of the one or more electrochemical cells 420. For example, the cavity 410 may be at least about 50%, optionally about 100%, and in certain aspects, optionally about 200%, larger than the one or more electrochemical cells 420. In certain variations, the cavity 410 may be at least 50%, optionally 100%, and in certain aspects, optionally 200%, larger than the one or more electrochemical cells 420. Like the battery pouch 300 illustrated in FIG. 3, the battery pouch 400 further includes an elastic material 450 that surround at least a portion of the one or more films 450. Like both the cavity 110 illustrated in FIG. 1 and the cavity 310 illustrated in FIG. 3, the cavity 410 further includes an electrolyte 430. Moreover, like both the battery pouch 100 illustrated in FIG. 1 and/or the battery pouch 300 illustrated in FIG. 3, the battery pouch 400 may further include one or more battery tabs 332, 334.

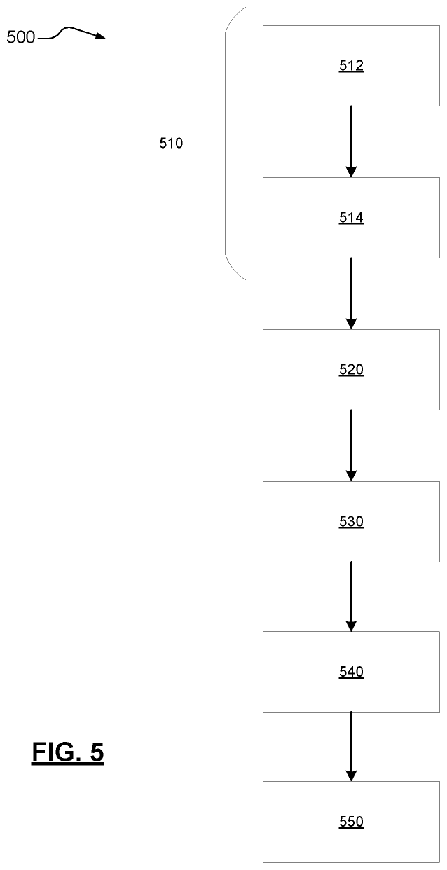

In various aspects, the present disclosure provides a method for forming a battery pouch having excess space or cavity pockets configured to accommodate volumetric expansions during thermal events, like the battery pouch 100 illustrated in FIG. 1. For example, an example method 500 for preparing a battery pouch is illustrated in FIG. 5. The method 500 includes adding 520 an electrolyte to a pouch cavity via an opening in the pouch, where the pouch encompasses one or more electrochemical cells (like the electrochemical cell 20 illustrated in FIG. 2). The electrolyte may be the same as or different from the electrolyte included in the one or more electrochemical cells. The electrolyte may be a non-aqueous liquid electrolyte solution (e.g., >1M) that includes a lithium salt dissolved in an organic solvent or a mixture of organic solvents.

In various aspects, the method 500 may further include preparing 510 the pouch. In certain variations, preparing 510 the pouch may include aligning 512 one or more films that form the pouch and sealing 514 one or more edges of the one or more films to form an enclosure having an opening to receive the one or more electrochemical cells and the electrolyte. In other variations, the one or more films may be aligned 512 on opposing sides of the one or more electrochemical cells and the one or more edges sealed 514 around the one or more electrochemical cell to form the enclosure having an opening to receive the electrolyte. In each variation, the one or more films are selected, and the seals positioned thereon, such that the pouch has a cavity that is at least about 50%, optionally about 100%, and in certain aspects, optionally about 200%, larger than the one or more electrochemical cells disposed therein. In certain variations, the pouch may have a cavity that is at least 50%, optionally 100%, and in certain aspects, optionally 200%, larger than the one or more electrochemical cells disposed therein. The one or more edges may be sealed 514 simultaneously or concurrently. The one or more edges may be sealed 514 using a heated bar, for example a heated metal bar, that melts the polymer coating (e.g., polymeric layer(s)) on the pouch material (e.g., metal foil).

The method 500 further includes sealing 530 the opening to form a closed pouch. The opening may be sealed 530 by a heated bar, for example a heated metal bar. The method 500 may further include degassing 540 the pouch cell. In various aspects, degassing 540 the pouch cell may include forming (e.g., cutting) a hole in the closed pouch to form an opening, applying vacuum to the opening, refilling the pouch with electrolyte, and resealing the pouch for reform a closed pouch. Further still, the method 500 may include folding 550 the excess material defining the space around the one or more electrochemical cells such that the battery pouch including the excess material has a desirable shape and size.

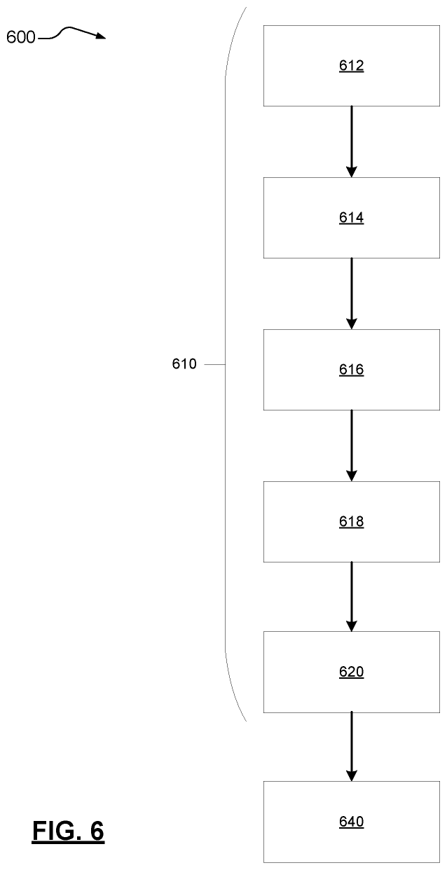

In various aspects, the present disclosure provides a method for forming a battery pouch having an elastic material and configured to accommodate volumetric expansions during thermal events, like the battery pouch 300 illustrated in FIG. 3. For example, an example method 600 for preparing a battery pouch is illustrated in FIG. 6. The method 600 includes contacting 640 one or more surfaces of a precursor battery pouch with an elastic polymer (e.g., rubber, latex, polychloroprene, nanotube rubber, fluoroelastomers, nylon fabric, and combinations thereof). In certain variations, the contacting 640 may include forming a pocket or sleeve using the elastic polymer, where the pocket has at least one opening to receive the precursor battery pouch. In such instances, the contacting 640 may include disposing the precursor battery pouch within the pocket of the elastic polymer and sealing the at least one opening. In other variations, the elastic material may be in the form rectangular film and the contacting 640 may include wrapping the elastic material around the precursor battery pouch, and in certain instances, sealing the edges of the elastic material.

In various aspects, the method 600 further includes preparing 610 the precursor battery pouch. In certain variations, preparing 610 the precursor battery pouch may include aligning 612 one or more films that form the pouch and sealing 614 one or more edges to form an enclosure having an opening to receive the one or more electrochemical cells and the electrolyte. In other variations, the one or more films may be aligned 612 on opposing sides of the one or more electrochemical cells and the one or more edges sealed 614 around the one or more electrochemical cell to form the enclosure having an opening to receive an electrolyte. In each variation, the one or more films are selected, and the seals positioned thereon, such that the pouch has a cavity that is only slightly larger than the one or more electrochemical cells. The one or more edges may be sealed 614 simultaneously or concurrently. The one or more edges may be sealed 614 by a heated bar, for example, a heated metal bar.

Preparing 610 the precursor battery pouch may further includes adding 616 an electrolyte to a pouch via the opening and sealing 618 the opening to form a closed pouch. The opening may be sealed 616 by heated bar, for example a heated metal bar. Preparing 610 the precursor battery pouch may also include degassing 620 the pouch cell. Degassing 620 the pouch cell may include trimming one or more sides of the closed pouch, or otherwise forming an opening in the closed pouch, and resealing any openings.

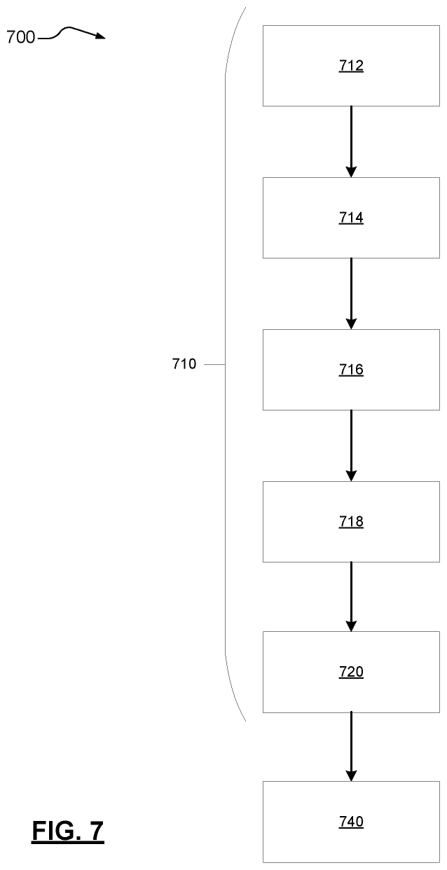

In various aspects, the present disclosure provides a method for forming a battery pouch having an elastic material, and also one or more capacity pockets, and configured to accommodate volumetric expansions during thermal events, like the battery pouch 400 illustrated in FIG. 4. For example, an example method 700 for preparing a battery pouch is illustrated in FIG. 7. The method 700 includes contacting 740 one or more surfaces of a precursor battery pouch with an elastic polymer (e.g., rubber, latex, polychloroprene, nanotube rubber, fluoroelastomers, nylon fabric, and combinations thereof).

In various aspects, the method 700 further includes preparing 710 the precursor battery pouch. In certain variations, preparing 710 the precursor battery pouch may include aligning 712 one or more films that form the pouch and sealing 714 one or more edges to form an enclosure having an opening to receive the one or more electrochemical cells and the electrolyte. In other variations, the one or more films may be aligned 712 on opposing sides of the one or more electrochemical cells and the one or more edges sealed 714 around the one or more electrochemical cell to form the enclosure having an opening to receive an electrolyte. In each variation, the one or more films are selected, and the seals positioned thereon, such that the pouch has a cavity that is at least about 50%, optionally about 100%, and in certain aspects, optionally about 200%, larger than the one or more electrochemical cells. In certain variations, the cavity may be at least 50%, optionally 100%, and in certain aspects, optionally 200%, larger than the one or more electrochemical cells. The one or more edges may be sealed 714 simultaneously or concurrently. The one or more edges may be sealed 714 by a heated bar, for example, a heated metal bar

Preparing 710 the precursor battery pouch may further includes adding 716 an electrolyte to a pouch via the opening and sealing 718 the opening to form a closed pouch. The opening may be sealed 716 by a heated bar, for example, a heated metal bar. Preparing 710 the precursor battery pouch may also include degassing 720 the pouch cell. Degassing 720 the pouch cell may include trimming one or more sides of the closed pouch, or otherwise forming an opening in the closed pouch, and resealing any openings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thermally stable battery pouch comprising:
one or more films assembled together to define a cavity;
a stack comprising a plurality of electrochemical cells disposed in the cavity; and
an electrolyte disposed in the cavity, wherein the cavity is at least about 50% larger than the stack.

2. The thermally stable battery pouch of claim 1, wherein the cavity comprises:
one or more pockets disposed on one or more sides of the stack.

3. The thermally stable battery pouch of claim 1, wherein the electrolyte fills greater than or equal to about 0.1 vol. % to less than or equal to about 10 vol. % of a total space between the one or more electrochemical cells and an interior surface of the one or more films.

4. The thermally stable battery pouch of claim 1, further comprising:
an elastic material film that coats at least a portion of an exterior surface of the one or more films.

5. The thermally stable battery pouch of claim 4, wherein the elastic material film has a thickness greater than or equal to about 10 μm to less than or equal to about 1 mm.

6. The thermally stable battery pouch of claim 4, wherein the elastic material film comprises an elastic material selected from the group consisting of: rubber, latex, polychloroprene, nanotube rubber, fluoroelastomers, nylon fabric, and combinations thereof.

6. A thermally stable battery pouch comprising:
one or more films assembled together to define a cavity, wherein the one or more films comprise a metal foil laminated with one or more polymeric layers;
an elastic material film that coats at least a portion of an exterior surface of the one or more films;
a stack comprising a plurality of electrochemical cells disposed in the cavity; and
an electrolyte disposed in the cavity.

7. The thermally stable battery pouch of claim 6, wherein the elastic material film has a thickness greater than or equal to about 1 μm to less than or equal to about 1 mm.

8. The thermally stable battery pouch of claim 6, wherein the elastic material film comprises an elastic material selected from the group consisting of: rubber, latex, polychloroprene, nanotube rubber, fluoroelastomers, nylon fabric, and combinations thereof.

9. The thermally stable battery pouch of claim 1, wherein the cavity comprises:
one or more pockets disposed on one or more sides of the stack.

10. The thermally stable battery pouch of claim 9, wherein the cavity is at least about 50% larger than the stack.

11. The thermally stable battery pouch of claim 6, wherein the electrolyte fills greater than or equal to about 0.1 vol. % to less than or equal to about 10 vol. % of a total space between the one or more electrochemical cells and an interior surface of the one or more polymeric films.

12. A method for forming a thermally stable battery pouch, the method comprising:
adding an electrolyte to a precursor battery pouch via an opening, wherein the precursor battery pouch defines a cavity configured to hold a stack comprising a plurality of electrochemical cells, wherein the cavity is at least about 50% larger than the stack; and
sealing the opening of the precursor battery pouch having the electrolyte and the stack disposed therein to form the thermally stable battery pouch.

13. The method of claim 12, wherein the method further comprises:
preparing the precursor battery pouch.

14. The method of claim 13, further comprising:
preparing the precursor battery pouch by:
aligning one or more films; and
sealing one or more edges of the one or more films to define the cavity of the precursor battery pouch and the opening.

15. The method of claim 14, wherein after the preparing, the method further comprises:
adding the stack of the one or more electrochemical cells to the cavity of the precursor battery pouch.

16. The method of claim 14, wherein the aligning of the one or more films comprises:
positioning the one or more films around the stack of the one or more electrochemical cells.

18. The method of claim 12, wherein the method further comprises:
contacting one or more exterior surfaces of the precursor battery pouch with an elastic material to form an elastic material film that coats at least a portion of an exterior surface of the thermally stable battery pouch.

19. The method of claim 18, wherein the elastic material is selected from the group consisting of: rubber, latex, polychloroprene, nanotube rubber, fluoroelastomers, nylon fabric, and combinations thereof.

20. The method of claim 12, wherein the method further comprises:
after the sealing, degassing the sealed precursor battery pouch to form the thermally stable battery pouch.
